(19) United States
(12) Patent Application Publication
(10) Pub. No.: US 2024/0375436 A1
(43) Pub. Date: Nov. 14, 2024

(54) WORK VEHICLE WITH ELECTRICALLY LOCKING CASTER

(71) Applicant: THE TORO COMPANY, Bloomington, MN (US)

(72) Inventor: Chris A. Wadzinski, Inver Grove Heights, MN (US)

(21) Appl. No.: 18/636,803

(22) Filed: Apr. 16, 2024

Related U.S. Application Data
(60) Provisional application No. 63/465,343, filed on May 10, 2023.

(51) Int. Cl. B60B 33/02; A01D 75/28; A01D 101/00

(52) U.S. Cl. CPC B60B 33/026; A01D 75/28; A01D 2101/00

(57) ABSTRACT

A work vehicle has at least one caster wheel on an end of the work vehicle. In response to a caster locking signal sent via an electrical controller, a solenoid is electrically activated to reversibly move a locking pin in an axial direction, causing transitions between unlocking and locking states. In the unlocking state, the locking pin is pulled away from the engagement surface. In the locking state, the locking pin is pushed towards the pivoting support to engage the locking void when the pivoting support is oriented in a predetermined rotation angle.

### RELATED PATENT DOCUMENTS

This application claims the benefit of U.S. Provisional Application No. 63/465,343, filed May 10, 2023, which is incorporated herein by reference in its entirety.

### SUMMARY

The present disclosure is directed to apparatuses and methods that facilitate locking casters in a work vehicle. In one embodiment, a work vehicle has two driven wheels on a first end of the work vehicle and a motor assembly coupled to rotate the two driven wheels. The work vehicle has an electrical controller operable to send a caster locking signal. The work vehicle also has one or more caster wheels on a second end of the work vehicle opposed to the first end. The one or more caster wheels are held by respective pivoting supports rotatably coupled to a frame of the work vehicle. Each pivoting support has an engagement surface and at least one locking void extending through the engagement surface. Associated with each of the one or more caster wheels is a solenoid fixably mounted to the frame of the work vehicle and electrically operable to reversibly move a plunger in an axial direction. The axial direction is at a non-zero angle to the engagement surface of the pivoting support. Also associated with each caster wheel is a locking pin coupled to the plunger and aligned with the locking void in a predetermined rotation angle of the pivoting support.

In response to the caster locking signal, the solenoid causes transitions between unlocking and locking states. In the unlocking state, the locking pin is pulled away from the engagement surface. In the locking state, the locking pin is pushed towards the pivoting support to engage the locking void when the pivoting support is oriented in the predetermined rotation angle.

In another embodiment, a method relates to operating a work vehicle having two driven wheels on a first end of the work vehicle. The work vehicle has at least one caster wheel in a second end of the work vehicle opposed to the first end. The method involves sending a caster locking signal via an electrical controller. In response to the caster locking signal, a solenoid is electrically activated to reversibly move a locking pin in an axial direction. The axial direction is at a non-zero angle to an engagement surface of a pivoting support of the caster wheel. In response to the caster locking signal, the solenoid causes transitions between unlocking and locking states. In the unlocking state, the locking pin is pulled away from the engagement surface. In the locking state, the locking pin is pushed towards the pivoting support to engage the locking void when the pivoting support is oriented in a predetermined rotation angle.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures. The drawings are not necessarily to scale.

FIG. 1 is a perspective view of a work vehicle according to an example embodiment;

FIG. 2 is a close-up perspective view of a caster locking mechanism of the work vehicle in FIG. 1;

FIG. 3 is an exploded of the caster of the caster locking mechanism in FIG. 2;

FIGS. 4-7 are cross-sectional views showing different states of a caster locking mechanism according to an example embodiment;

FIG. 8 is a set of cross-sectional views of a caster locking mechanism according to another example embodiment;

FIG. 9 is perspective view of parts of a caster locking mechanism according to another example embodiment;

FIGS. 10-12 are circuit diagrams showing electrical controllers according to various embodiments;

FIG. 13 is a signal timing diagram showing example operations of the circuit diagram of FIG. 12; and

FIGS. 14 and 15 are flowcharts showing methods according to example embodiments.

### DETAILED DESCRIPTION

In the following detailed description of illustrative embodiments, reference is made to the accompanying figures of the drawing which form a part hereof. It is to be understood that other equivalent embodiments, which may not be described and/or illustrated herein, are also contemplated.

The present disclosure relates generally to work vehicles that use a zero-turn wheel system, in which the vehicles have differentially driven rear wheels and freely rotatable front wheels, or casters. This allows the vehicle to have a tight turn radius zero when the wheels are driven in opposite directions. Zero-turn system are often used in ground care machines such as mowers. While specific embodiments below are shown and described as a mower, such a configuration is illustrative only. Systems and methods described herein may also have application to other work machines including, for example, debris blowers/vacuums/sweepers, aerators, dethatchers, material spreaders/sprayers, snow and ice treatment, weeding machines for weed remediation mobile watering/treating vehicles, indoor working vehicles such as vacuums and floor scrubbers/cleaners, construction and utility vehicles, observation vehicles, and load transportation (e.g., including people and things, such as people movers and hauling equipment). The embodiments herein may also be applicable to work machines with a non-zero turn configuration, e.g., machines that do not differentially steer the rear wheels.

One issue with zero-turn mowers is navigating hills. The front caster wheels do not have much traction, which is beneficial for tight maneuvering in flat work areas, but can reduce stability on hills. The caster wheels can freely pivot, therefore have a tendency to align to the path of least resistance, which may not be the direction desired by the operator, e.g., when the mower is tilted from side-to-side on a slope. In this disclosure, methods and apparatuses are described that can facilitate manual or automatic locking of zero-turn caster wheels during operation, thereby improving stability in some situations such as navigating hills.

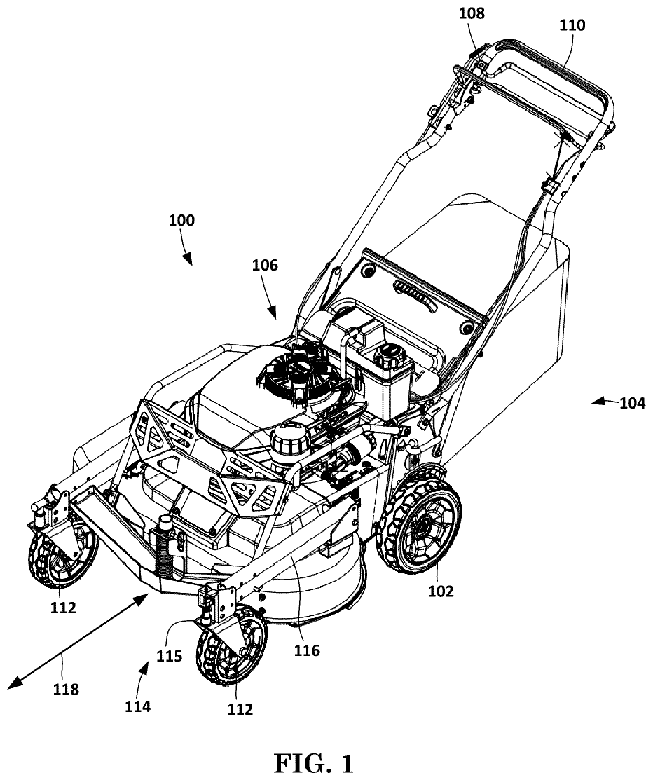

In FIGS. 1, 2, and 3, perspective views show details of a zero-turn work vehicle 100 according to one or more embodiments. As seen in FIG. 1, the zero-turn work vehicle in this example is a walk behind mower, but the description of FIG. 1 may be applicable to any work vehicle as described above. The zero-turn work vehicle includes two driven wheels 102 on a first end 104 of the work vehicle 100 (only one of the wheels 102 is seen in this view). A motor assembly 106 is coupled to rotate the two driven wheels 102. The motor assembly 106 in this example includes an internal combustion engine (ICE) and associated components such as a fuel tank, transmission, etc. In other embodiments, the motor assembly 106 may include an electric motor and associated battery, power controller, etc.

An electrical controller 108 is operable to send a caster locking signal. In this example the electrical controller 108 is a switch mounted on a handle 110 of the mower. In other embodiments, the electrical controller 108 may include different or additional components such as a sensor-driven controller that can send the caster locking signal in response to a sensor signal, e.g., vehicle tilt sensor. The electrical controller 108 may interact with other electrical devices that may enable or disable the caster locking signal, such as main power switch, dead man switch, etc.

One or more caster wheels 112 are located on a second end 114 of the work vehicle 100 opposed to the first end 104. The one or more caster wheels 112 are held by respective pivoting supports 115 rotatably coupled to a frame 116 of the work vehicle 100. The rotation of the pivoting supports 115 may be described herein as a “steering rotation” to distinguish from a rolling rotation of the caster wheels 112 around their respective axes. While the caster wheels 112 do not actively steer the vehicle 100, they do respond to differential steering inputs to the rear wheels 102 by changing their rotational angle to correspond to the steering angle. As will be described in detail below, the vehicle includes an electrically operable caster lock assembly that can lock the caster wheels 112 and pivoting supports 115 at a predetermined steering angle (e.g., aligned with longitudinal direction 118) and prevent significant rotation away from that steering angle.

Note that in this embodiment the driven wheels 102 are at the rear of the vehicle and the caster wheels 112 are at the front. However, the caster locking arrangements described below may be used in an opposite arrangement where front wheels are driven wheels and rear wheels are caster wheels. This may also be used in arrangements where the driven wheels are replaced with some other ground traversal mechanism such as treads.

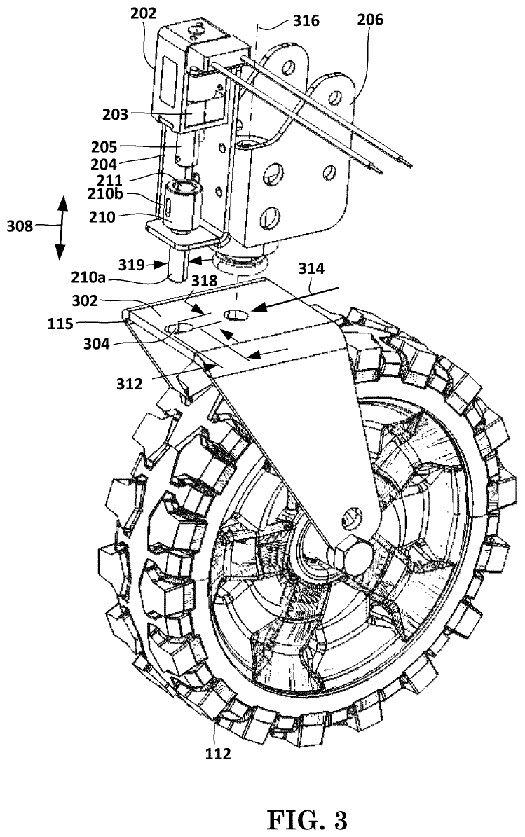

As best seen in the exploded view of FIG. 3, each pivoting support 115 has an engagement surface 302 and at least one locking void 304 extending through the engagement surface 302. In this embodiment, the locking void 304 is configured as a locking slot having a major dimension 312 in a major direction 314 that extends radially from a rotational axis 316 of the pivoting support and a minor dimension 318 corresponding to a diameter 319 of a locking portion 210a of the locking pin 210. The major dimension 312 is larger than the minor dimension 318. The rotational axis 316 corresponds to an axis of steering rotation as described above. By making the locking void 304 a slot, the assembly is less sensitive to misalignments between the locking pin 210 and the pivoting support 115 in the major direction 314. The minor dimension 318 can be equal to the pin diameter 319 plus a clearance value to allow smooth engagement and disengagement while preventing excessive steering rotation of the caster wheel 112 when locked.

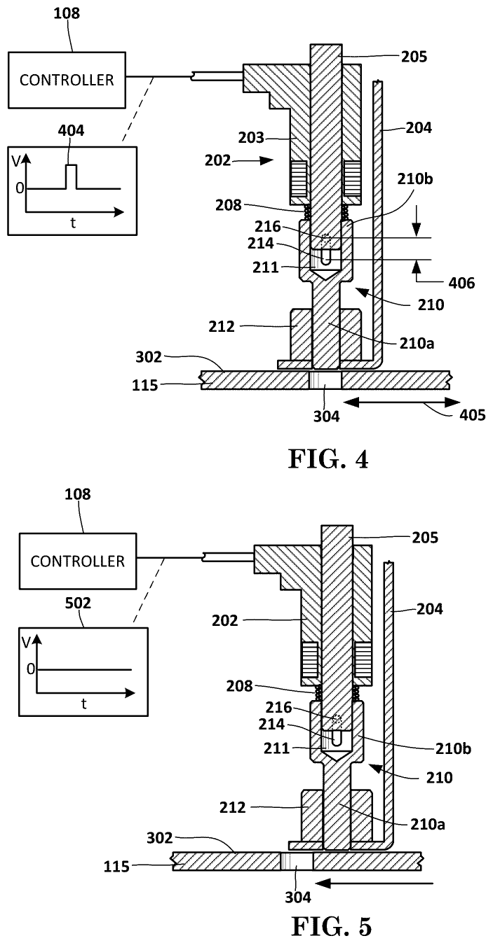

Associated with each of the one or more caster wheels 112 is a solenoid 202 fixably mounted to the frame 116 of the work vehicle, e.g., via lock support member 204 and end bracket 206. The solenoid 202 is electrically operable to reversibly move a plunger 205 in an axial direction 308. The axial direction 308 is at a non-zero angle to the engagement surface 302 of the pivoting support 115. The locking pin 210 may have an enlarged portion 210b with a hole 211 extending in the axial direction 308 that encompasses an end of the plunger 205. The plunger 205 is slidably displaceable within the hole 211 by a predetermined free travel distance (see free travel distance 406 in FIG. 4) before engaging the locking pin 210. This is accomplished via a slot 214 in a wall of the hole of the enlarged portion 210b and a slot pin 216 attached to the solenoid plunger. The slot pin 216 extends into the slot 214 such that an elongated dimension of the slot 214 defines the free travel distance.

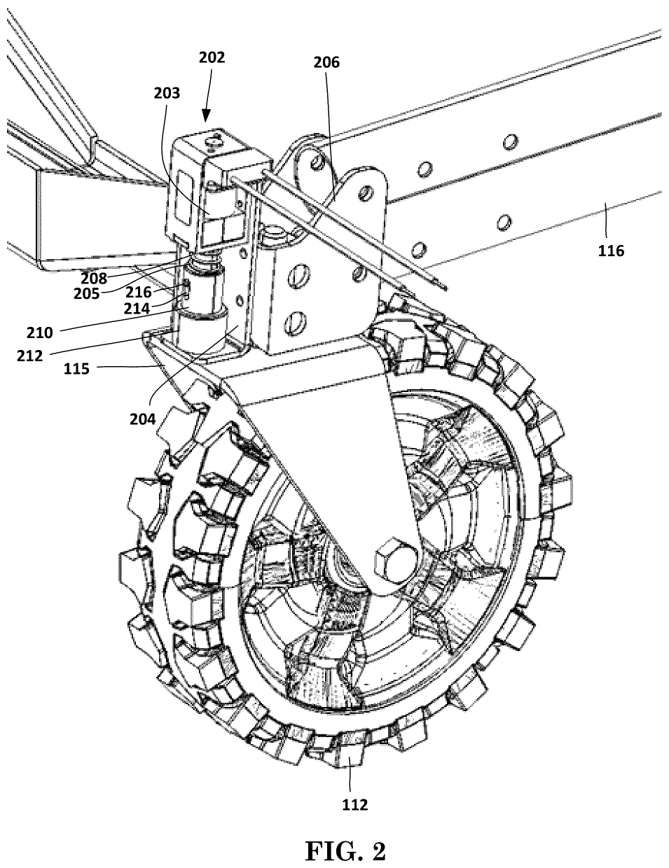

The locking pin 210 is aligned with the locking void 304 in a predetermined rotation angle of the pivoting support 115. Generally, the predetermined rotation angle results in the caster wheel 112 being aligned with a longitudinal axis 118 of the work vehicle 100 (see FIG. 1). As seen in FIG. 2, a biasing member 208 (e.g., a coil spring) is between an enlarged portion 210b of the locking pin 210 and a body 203 of the solenoid 202. The biasing member 208 applies a force on the locking pin 210 in the axial direction 308 towards the locking void 304. Also seen in FIG. 2 is a bushing 212 that is aligned with and encompasses the locking part 210a of the locking pin 210. The bushing 212 and the locking support member 204 minimize transmission of lateral forces from the pivoting support 115 to the plunger 205. The biasing member 208 and bushing 212 are not shown in FIG. 3 to provide a clearer view of other components.

In response to the caster locking signal, the solenoid 202 transitions from unlocking and locking states. In response to a repeat of the caster locking signal or in response to a caster unlocking signal, the solenoid 202 transitions from the locking to unlocking states. While these states are described in terms of solenoid activation, e.g., extension and retraction of the plunger 205, unlocking and locking states also include states of other components, including the locking pin 210, the biasing member 208, and the pivoting support 115. In FIGS. 4-7, cross sectional views show operation of a caster locking mechanism according to an example embodiment.

In FIG. 4, the caster locking mechanism is shown in the unlocking state. This can be achieved by a solenoid unlocking signal 404 that causes the plunger 205 to be pulled upwards into the solenoid body 203. The solenoid 202 in this example is a latching solenoid wherein the plunger 205 is magnetically held at the retracted and extended positions. Thus, the signal 404 only need be a momentary input of electrical current, e.g., as provided by a momentary contact switch. Note that the signal 404 is shown as a positive voltage pulse in FIG. 4 but could be a negative pulse in other embodiments.

In the unlocking state, the slot pin 216 is engaged with a top part of the slot 214 such that the locking pin 210 is pulled toward the solenoid 202 and the biasing member 208 is compressed. This disengages the locking portion 210a of the locking pin 210 from the locking void 304, allowing the pivoting support 115 to rotate, indicated by side-to-side arrow 405 in FIG. 4. In FIG. 5, the pivoting support 115 is shown rotated away from the predetermined rotation angle, indicating that the caster wheel 112 is allowed to rotate (steer) freely in the unlocking state. Note that signal diagram 502 shows no input voltage to the solenoid 202, as the internal locking mechanism of the solenoid 202 (e.g., magnet) can maintain the unlocking state without requiring continual application of electrical power.

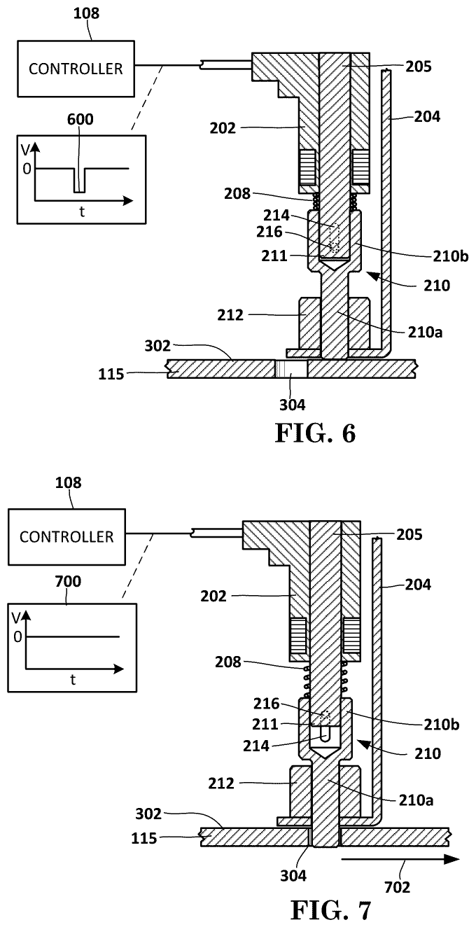

The diagram in FIG. 6 shows a transition from the unlocking state to the locking state. In FIG. 6, the pivoting support 115 is shown oriented relative to the locking pin 210 the same as in FIG. 5, such that the locking part 210a is not aligned with the locking void 304. A solenoid locking signal 600 is applied to the solenoid 202 to enter the locking state. The signal is 600 a negative pulse, which is inverse from the locking signal 404 seen in FIG. 4, and as previously noted, the polarities of the signals may be reversed in other embodiments. The locking state pushes the locking pin 210 to extend towards the pivoting support 115 and engage the locking void 304 when the pivoting support 115 is oriented in the predetermined rotation angle as seen in FIG. 7.

As seen in FIG. 6, when the plunger 205 moves downward, it moves the pin 216 to the bottom of the slot 214, allowing the biasing member 208 to push the locking pin 210 towards the pivoting support 115. Because the pivoting support 115 is not oriented in the predetermined rotation angle in FIG. 6, the locking part 210a of the locking pin 210 rides against the engagement surface 302. This illustrates that in the locking state, the caster wheel 112 may not be locked unless and until the pivoting support 115 has become oriented in the predetermined rotation angle.

Once the pivoting support 115 has become oriented in the predetermined rotation angle as seen in FIG. 7 (through movement indicated by arrow 702), the biasing member 208 forces the locking part 210a through the locking void 304 and locks the pivoting support 115, preventing free steering rotation of the caster wheel 112. Note that signal diagram 700 shows no input voltage to the solenoid 202, as the internal locking mechanism of the solenoid 202 (e.g., magnet) can maintain the locking state without requiring continual application of electrical power. The movement indicated by arrow 702 can be induced by the operator of the work vehicle, e.g., by steering from left to right and back again after initiating the locking state, in order to physically lock the casters.

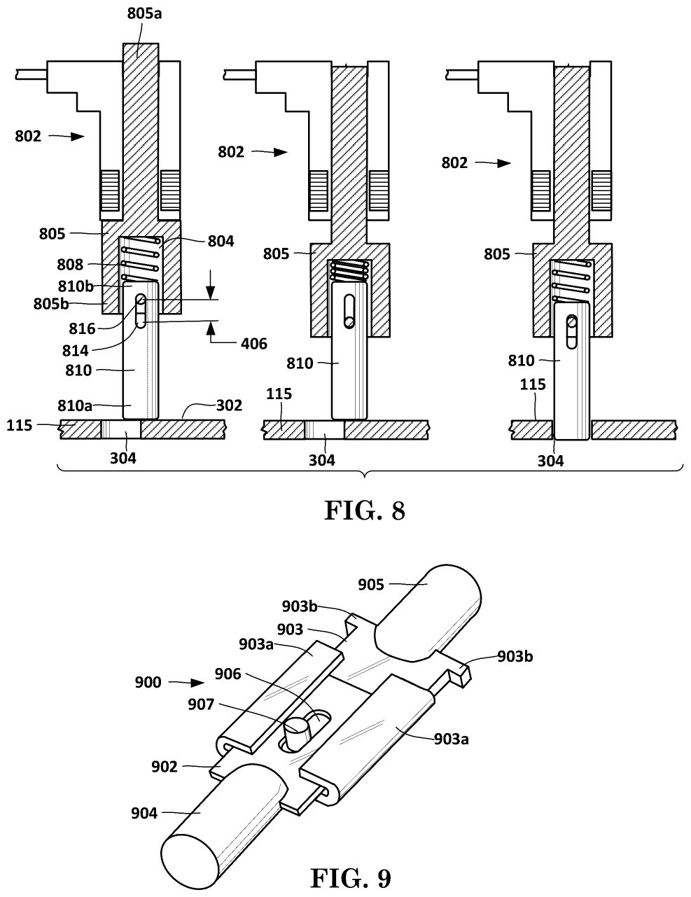

Generally, the locking pin 210 and the solenoid plunger 205 can move relative to one another over a free travel distance 406 (see FIG. 4) without engagement so that the solenoid plunger 205 can extend and be latched in place even if the locking pin 210 is not aligned with the locking void 304. The biasing member 208 maintains a force on the locking pin 210 that pushes the locking pin 210 into the locking void once they come into alignment, thereby locking the caster wheel 112 from steering rotation. In the illustrated embodiments, this is accomplished via the slot 214 in the wall of the enlarged part 210b of the locking pin 210, which engages with slot pin 216 attached to the plunger 205 at limits of the slot 214. It will be understood that other engagement means may provide a similar plunger free travel with subsequent biasing of the locking pin into the locking void 304. In FIG. 8, a cross-sectional diagram shows a locking pin and solenoid plunger interface according to another example embodiment.

In FIG. 8, a solenoid 802 has a plunger 805 with an actuated portion 805a and an enlarged portion 805b. The enlarged portion 805b defines a hole 804 in which a locking pin 210 can move freely. A biasing member 808 (e.g., a coil spring) is disposed in the hole 804 between the plunger 805 and the locking pin 810. Note that this arrangement may include other components shown in other embodiments, such as bushing 212 and lock support member 204, which are not shown here.

Different from the previous embodiments, this embodiment uses a straight locking pin 810 and a plunger 805 adapted to receive an end 810b of the locking pin 810 that is opposed to a locking portion 810a. As with the previous embodiments, a slot 814 is formed within the locking pin 810 and a slot pin 816 is attached to the plunger 805. The slot 814 and slot pin 816 can provide an equivalent free travel distance 406 as provided in other embodiments. Also note that in an alternate embodiment, a slot may instead be formed on a wall of the enlarged part 805b of the plunger 805 and the slot pin attached to the locking pin 810, similar to what is shown in FIGS. 4-7 but with the plunger 205 and locking pin 210 being reversed. The embodiments in FIGS. 4-7 may also be adapted to instead use a sliding interface as shown in FIG. 8, with a slot in the plunger 205 and a pin fixed in the enlarged part 210b of the locking pin 210.

In the lefthand view of FIG. 8, a first activation of the solenoid 802 transitions to and maintains the unlocking state, in which the locking pin 810 is pulled away from the engagement surface 302. In the middle and right views, a second activation of the solenoid 802 transitions to and maintains the locking state in which the locking pin 810 is pushed towards the pivoting support 115. In the righthand view, the locking pin 810 has engaged the locking void 304 when the pivoting support 115 is oriented in the predetermined rotation angle.

In FIG. 9, a perspective view shows a sliding interface 900 that may be implemented in a caster locking system according to another embodiment. This sliding interface uses two plates 902, 903, the second plate 903 having folded edges 903a that surround edges of the first plate 902. The plates 902, 903 are attached to respective cylindrical parts 904, 905 that could serve as (or be coupled to) any combination of a locking pin and solenoid plunger. A slot 906 in first plate 902 and slot pin 907 attached to second plate 903 can allow for a predefined free travel distance as in previous embodiments and may be reversed from what is shown here (e.g., slot 906 in second plate 903 and slot pin 907 attached to first plate 902). A biasing member (not shown) can be configured to press against one of the plates 902, 903, e.g., on tabs 903b on the second plate 903, to provide an insertion force as in previous embodiments.

In the embodiments described above, at least one solenoid and an associated mechanical interface is used to lock at least one caster wheel. Because zero turn vehicles commonly have two caster wheels, there may be one solenoid associated with each wheel. In some embodiments, one solenoid may be able to lock more than one wheel, such as if two caster wheels are coupled to rotate together via a tie rod or the like, and/or if a mechanical link is provided between two locking mechanisms. Thus, where embodiments are described below as using two or more solenoids, it is understood that such embodiments may be adaptable for use with a single solenoid.

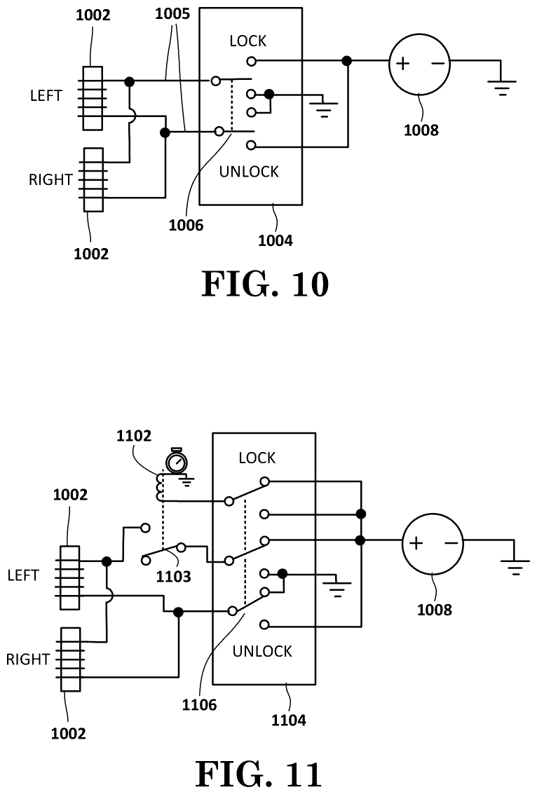

In FIG. 10, a schematic diagram shows a caster locking control circuit according to an example embodiment. Two solenoids 1002 are shown that are associated with two different caster wheels. An electrical controller 1004 is configured to send a caster locking signal, which in this case are electrical outputs 1005. The electrical controller 1004 includes a double pole, double throw switch 1006 that is mechanically biased to a center position. The switch 1006 can be momentarily held to either the unlock or lock positions, such that outputs 1005 will momentarily assume different polarities when in those respective positions. The switch 1006 will return to center position after being released removing current from the solenoids 1002. Internal locking mechanisms of the solenoids 1002 will hold their respective plungers in the unlock or lock positions (corresponding to first and locking states, respectively) after the current has been removed. The current used to unlock and lock the solenoids 1002 comes from a power source 1008, such as a vehicle battery or generator. Note that the illustrated circuit is a direct current (DC) circuit but this circuit (and other circuits described herein) could be adapted to use an AC power source, e.g., by adding a voltage rectifier.

Note that, by itself, the switch 1006 will not provide indication to the operator whether the caster wheels are currently in the locked or unlocked state because it is mechanically biased to return to the center position. A two-position switch can be used instead of switch 1006, although such a switch might always apply voltage to the solenoids 1002. In some embodiments, a locked/unlocked indicator (e.g., indicator light, electro-mechanical indicator; not shown) may be used together with the return to center switch 1006 to indicate locked and unlocked states in one or more embodiments.

In FIG. 11, a schematic diagram shows a caster locking control circuit according to another example embodiment. An electrical controller 1104 in this example includes a triple pole, double throw, two position switch 1106. The switch 1106 will remain in either the unlock or lock positions, such that the switch 1106 can, by itself, indicate state of the solenoids 1002. To avoid constant application of current to the solenoids 1002 after they have latched, a timer relay 1102 can be used which will engage (closing switch 1103) once power is supplied, then disengage (opening switch 1103) after a preset amount of time. When the switch 1106 is transitioned between locked and unlocked states, this will momentarily remove power from the timer relay 1102, causing it to reset. Note that the solenoids 1002 may have a build in functionality similar to the timer relay 1102 such that a separate timer relay 1102 need not be used. For example, the solenoids 1002 may internal components such as limit switches and diodes that remove power from a coil (or block current from flowing in one direction or another to a coil) once the solenoid 1002 has latched in an extended or retracted position.

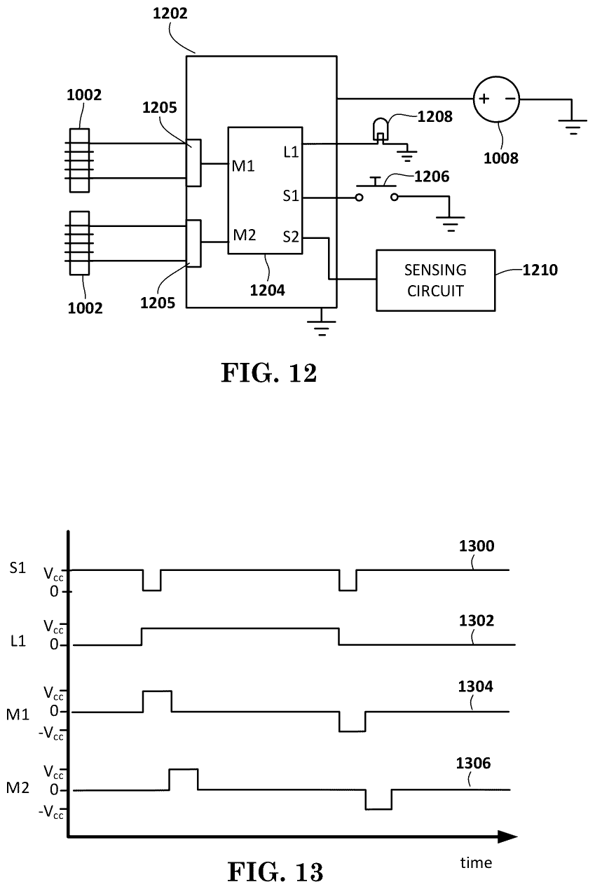

In FIG. 12, a schematic diagram shows a caster locking control circuit according to another example embodiment. In this embodiment, an electrical controller 1202 includes a logic circuit 1204 that controls power to the solenoids 1002 via power interfaces 1205, which will change output polarity in response to an input signal going positive or negative. A momentary switch 1206 and indicator 1208 are also shown that allow the operator to manually lock and unlock the casters and provide visual indication of the current state. Note that a two position, latching toggle switch (similar to switch 1106) may be used in place of the momentary switch 1206 and indicator 1208, and a two position, momentary switch (similar to switch 1006) can be used with the indicator 1208. A sensing circuit 1210 may instead or in addition be used to lock and unlock the casters. The sensing circuit 1210 may include, for example, accelerometers and/or a tilt switch that detect when the vehicle is tilted above and below a threshold value.

Pressing the momentary switch 1206 will cause a caster locking signal to be sent to the logic circuit 1204. Because the caster locking signal acts as a toggle, the caster locking signal will both lock and unlock that casters wheels via solenoids 1002. The logic circuit 1204 may track an internal locking state of the caster wheels, and send respective solenoid locking and unlocking signals via power interfaces 1205. For purposes of this disclosure, the operator may send a single signal (e.g., via a momentary switch) referred to herein as a caster locking signal. In this example, repetitions of the single signal may result in different solenoid locking and unlocking signals. In other embodiments, e.g., as shown in FIGS. 10 and 11, the operator may also send an express caster unlocking signal in addition to the locking signal.

One capability provided by a logic circuit 1204 as shown in FIG. 11 is programmability, such that operation of the system can be tailored for different scenarios, and readily changed in development and use. Fixed logic circuits could be used, e.g., collections of NAND gates assembled into a state machine. Programmable logic circuits could be used, e.g., field-programmable gate arrays (FPGAs), microcontrollers, etc.

One example of how the logic circuit 1204 may operate is shown in the signal diagram of FIG. 13. Trace 1300 represents a signal measured from switch 1206, which is momentarily grounded when the locking function is toggled on and off. Trace 1302 represents a voltage applied to the indicator 1208 indicating the state, e.g., a locked state. The trace 1302 is triggered on and off via a falling edge of trace 1300. Traces 1304, 1306 indicate a locking input (positive voltage) or unlocking input (negative input) to lock and unlock the solenoids 1002. There is a delay between the pulses in traces 1304, 1306, which can reduce a total current load on the power supply 1008. It will be understood that the pulses in these signals could be overlapping or simultaneous in other embodiments.

The use of custom configurable and/or programmable logic circuit 1204 can simplify creating a custom system behavior as exemplified in FIG. 13. For example, the positive and negative pulses in traces 1304, 1306 are for a longer duration than the switch pulses in trace 1300. In this way, the logic circuit 1204 can be configured make the system less sensitive to how long the user depresses the switch 1206. In another example, the sensing circuit 1210 may provide a similar trace as trace 1300, or alternately send positive and negative transitions or pulses when a triggering event occurs, e.g., exceeding a tilt angle threshold. The user input could alternatively, instead of the momentary switch 1206, be a two-position toggle switch that sends two different signal levels depending on position, such that the indicator 1208 may not be needed.

The logic circuit 1204 can be extended to add this and other inputs, including inputs (e.g., manual or automatic mode setting) that governs how the user inputs and sensor inputs interact. The logic circuit 1204 can be extended to add additional functionality using the same controls. For example, by holding down the momentary switch 1206 for a predetermined time, the logic circuit 1204 can initiate a “stuck lock” signal that repeatedly pulses the solenoids 1002 in case one of them becomes jammed.

The electrical controller 1202 may provide other circuit functionality not shown here. For example, the electrical controller 1202 may include electrical noise filter, switch debounce circuits, fault detection, power conditioning, etc. The electrical controller 1202 may be a system controller that governs other operations, such as battery charging, steering controls, engine controller unit, etc.

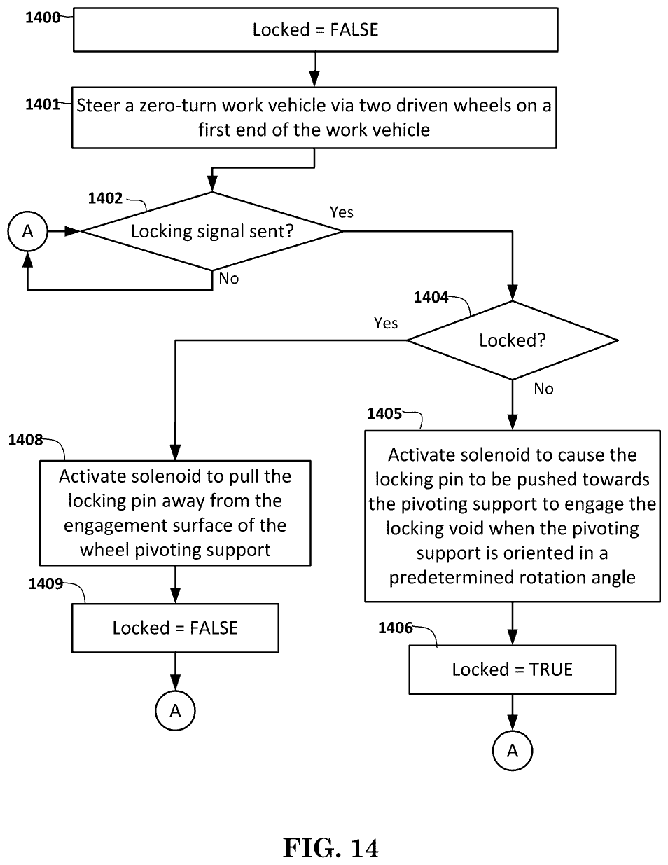

In FIG. 14, a flowchart shows a method according to an example embodiment. The method takes place while steering 1401 a zero-turn work vehicle via two driven wheels on a first end of the work vehicle. The work vehicle has at least one caster wheel in a second end of the work vehicle opposed to the first end. At block 1400, state variable is initialized, e.g., on vehicle power up. This variable “Locked” represents the locked state (Locked==TRUE) or unlocked state (Locked==FALSE) of the locking assembly. As described elsewhere herein, the casters may not be mechanically locked in the locking state until they are put in a predetermined rotation angle.

At some point, either through user input or a caster locking signal is sent 1402, e.g., from an electrical controller. Block 1402 is the entry point of an infinite loop in which the locking signal is polled. In this embodiment, the locking signal is a toggle, such that the same signal will perform different actions based on the current state, which is indicated by the value of the “Locked” state variable. In response to the caster locking signal a solenoid is electrically activated to reversibly move a locking pin in an axial direction, the axial direction is at a non-zero angle to an engagement surface of a pivoting support of the caster wheel.

In response to the caster locking signal, the solenoid causes transitions between unlocking and locking states. If the current state is unlocked (block 1404 returns “No”), the solenoid is activated 1405 to push the locking pin towards the pivoting support to engage the locking void when the pivoting support is oriented in a predetermined rotation angle. The state variable is updated at block 1406. If the current state is locked (block 1404 returns “Yes”), the solenoid is activated 1408 to pull the locking pin is pulled away from the engagement surface. The state variable is updated at block 1409.

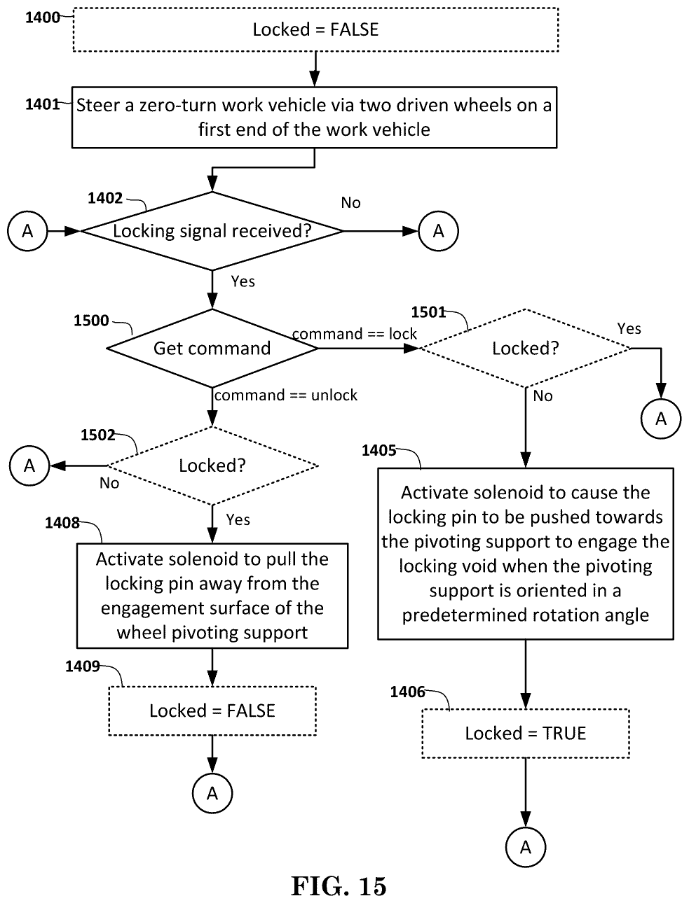

In FIG. 15, a flowchart shows a method according to another example embodiment. This is similar to the flowchart shown in FIG. 14, except that the locking signal received at block 1402 is not a toggle but includes a specific command to lock or unlock (or may be separate caster locking and unlocking signals). This may be implemented in a circuit, for example, by using negative or positive voltages as one of the commands, and zero voltage when no command currently being issued. Therefore block 1500 determines which action is commanded, and then proceeds to activate the solenoid as previously described. Note that blocks 1501 and 1502 test to see if the command is the same as the current state (e.g., command is to lock when the state is locked) and skip any solenoid activation if that is the case. These decision blocks 1501, 1502 are optional when explicit commands are used, as are blocks 1400, 1406, and 1408 which maintain the state. In the state variable is not used, this may be functionally equivalent to the switched circuits in FIGS. 10 and 11.

While the present disclosure is not so limited, an appreciation of various aspects of the disclosure will be gained through a discussion of the specific illustrative aspects provided below. Various modifications of the illustrative aspects, as well as additional aspects of the disclosure, will become apparent herein.

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the machine is in an operating configuration. These terms are used only to simplify the description, however, and not to limit the interpretation of any embodiment described. As used herein, the terms “determine” and “estimate” may be used interchangeably depending on the particular context of their use, for example, to determine or estimate a position or pose of a vehicle, boundary, obstacle, etc.

Further, it is understood that the description of any particular element as being connected to or coupled to another element can be directly connected or coupled, or indirectly coupled/connected via intervening elements.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather determined by the claims appended hereto.

1. A work vehicle, comprising:
two driven wheels on a first end of the work vehicle;
a motor assembly coupled to rotate the two driven wheels;
an electrical controller operable to send a caster locking signal;
one or more caster wheels on a second end of the work vehicle opposed to the first end, the one or more caster wheels held by respective pivoting supports rotatably coupled to a frame of the work vehicle, each pivoting support comprising an engagement surface and at least one locking void extending through the engagement surface; and
associated with each of the one or more caster wheels:
a solenoid fixably mounted to the frame of the work vehicle and electrically operable to reversibly move a plunger in an axial direction, the axial direction being at a non-zero angle to the engagement surface of the pivoting support;
a locking pin coupled to the plunger and aligned with the locking void in a predetermined rotation angle of the pivoting support;
wherein, in response to the caster locking signal, the solenoid causes transitions between unlocking and locking states, wherein in the unlocking state, the locking pin is pulled away from the engagement surface, and in the locking state, the locking pin is pushed towards the pivoting support to engage the locking void when the pivoting support is oriented in the predetermined rotation angle.

2. The work vehicle of claim 1, further comprising a locking support member fixably mounted to the frame, the locking support member comprising a bushing aligned with and encompassing a locking part of the locking pin, the bushing and the locking support member minimizing transmission of lateral forces from the pivoting support to the plunger.

3. The work vehicle of claim 1, wherein if the pivoting support is not oriented at the predetermined rotation angle in the locking state, an end of the locking pin slides along the engagement surface in response to rotations of the pivoting frame.

4. The work vehicle of claim 1, wherein the solenoid comprises a latching solenoid that latches the plunger in retracted and extended orientations in the respective unlocking and locking states, the latching solenoid holding the plunger in the retracted and extended orientations after removal of electrical power to the latching solenoid.

5. The work vehicle of claim 4, wherein the locking pin is movable relative to the plunger over a free travel distance, wherein the free travel distance allows the latching solenoid to hold the plunger in the extended orientation when the pivoting support is not oriented in the predetermined rotation angle.

6. The work vehicle of claim 5, further comprising a biasing member that biases the locking pin towards the engagement surface, the biasing member pushing the locking pin into the locking void when the pivoting support becomes oriented in the predetermined rotation angle.

7. The work vehicle of claim 6, wherein the locking pin comprises an enlarged portion comprising a hole in the axial direction that encompasses an end of the plunger, the plunger slidably displaceable within the hole by the free travel distance before engaging the locking pin.

8. The work vehicle of claim 7, wherein the enlarged portion comprises a slot in a wall of the hole of the enlarged portion and the plunger comprises a slot pin that extends into the slot, an elongated dimension of the slot defining the free travel distance.

9. The work vehicle of claim 7, wherein the biasing member is between the enlarged portion and a body of the solenoid.

10. The work vehicle of claim 1, wherein the locking void comprises a locking slot having a major dimension in a major direction that extends radially from a rotational axis of the pivoting support and a minor dimension corresponding to a diameter of a locking portion of the locking pin, the major dimension larger than the minor dimension.

11. The work vehicle of claim 1, wherein the one or more caster wheels comprise two or more caster wheels, and wherein the two or more solenoids associated with the two or more caster wheels are transitioned together between the unlocking and locking states via the caster locking signal.

12. The work vehicle of claim 1, wherein the work vehicle comprises a walk behind ground care vehicle.

13. The work vehicle of claim 1, wherein the motor assembly comprises an electric motor and the work vehicle comprises a battery that powers the electric motor and the solenoid.

14. The work vehicle of claim 1, wherein the electrical controller comprises a user actuated switch that provides the caster locking signal.

15. The work vehicle of claim 1, wherein the electrical controller is further configured to:
measure a tilt of the work vehicle via a sensor; and
send the caster locking signal based on the tilt going above or below a threshold.

16. A method of operating a work vehicle having two driven wheels on a first end of the work vehicle, the work vehicle having at least one caster wheel on a second end of the work vehicle opposed to the first end, the method comprising:
sending a caster locking signal via an electrical controller;
in response to the caster locking signal, electrically activating a solenoid to reversibly move a locking pin in an axial direction to transition between unlocking and locking states, the axial direction being at a non-zero angle to an engagement surface of a pivoting support of the caster wheel, wherein:
in the unlocking state, the locking pin is pulled away from the engagement surface; and
in the locking state, the locking pin is pushed towards the pivoting support to engage a locking void of the pivoting support when the pivoting support is oriented in a predetermined rotation angle.

17. The method of claim 16, further comprising minimizing transmission of lateral forces from the pivoting support to a plunger of the relay via a bushing aligned with and encompassing a locking part of the locking pin, the bushing mounted to a frame of the work vehicle.

18. The method of claim 16, wherein if the pivoting support is not oriented at the predetermined rotation angle in the locking state, an end of the locking pin slides along the engagement surface in response to rotations of the pivoting support.

19. The method of claim 16, wherein the solenoid comprises a latching solenoid that latches a plunger in retracted and extended orientations in the respective unlocking and locking states, the latching solenoid holding the plunger in the retracted and extended orientations after removal of electrical power to the latching solenoid;
wherein the locking pin is movable relative to the plunger over a free travel distance, the free travel distance allowing the latching solenoid to hold the plunger in the extended orientation when the pivoting support is not oriented in the predetermined rotation angle; and
wherein the method further comprises biasing the locking pin towards the engagement surface in the locking state via a biasing member that pushes the locking pin into the locking void when the pivoting support becomes oriented in the predetermined rotation angle.

20. The method of claim 16, further comprising:
measuring a tilt of the work vehicle via a sensor; and
sending the caster locking signal based on the tilt going above or below a threshold.
